(19) United States
(12) Patent Application Publication
(10) Pub. No.: US 2022/0099448 A1
(43) Pub. Date: Mar. 31, 2022

(54) SYSTEM AND METHOD FOR TRACKING AND PREDICTING RIDERSHIP ON A MULTI-PASSENGER VEHICLE

(71) Applicant: 4mativ Technologies, Inc, St. Paul, MN (US)

(72) Inventors: Ryan Goldsberry, Huntersville, NC (US); Carl Allen, St. Paul, MN (US)

(21) Appl. No.: 17/033,233

(22) Filed: Sep. 25, 2020

(51) Int. Cl. G01C 21/34; H04R 19/04

(52) U.S. Cl. CPC G01C 21/3438; H04R 19/04; G01C 21/3492

(57) ABSTRACT

It is an object of the present invention to provide a system and method for tracking ridership on a multi-passenger vehicle to perform such that the capacity of the multi-passenger vehicle may be optimized to reduce costs. A biometric device in the multi-passenger vehicle is provided and configured to capture sound data of a number of riders over a predetermined time. A computer or user is configured to analyze the captured sound data from the predetermined time such that a future ridership schedule of the number of riders may be predicted enabling efficient use of one or more multi-passenger vehicles based on the future ridership schedule.

### CROSS-REFERENCE TO RELATED APPLICATIONS

N/A

### BACKGROUND OF THE INVENTION

### 1. Field of the Invention

The invention generally relates to biometric systems, and more particularly, a system and method for tracking and predicting ridership on a multi-passenger vehicle.

### 2. Description of Related Art

Biometric methods and systems are used to identify and authenticate people for various purposes. In some instances, biometric methods and systems are used to track the location of one or more individuals. Various biometric techniques are known in the art, including but not limited to eye scanning, finger scanning and voice recognition. However, there is room for improvement in the use of biometrics in the field of ridership tracking on multi-passenger vehicles, such as school buses.

### BRIEF SUMMARY OF THE INVENTION

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

It is an object of the present invention to provide a system and method for tracking ridership on a multi-passenger vehicle to perform such that the capacity of the multi-passenger vehicle may be optimized to reduce costs.

In order to do so, a system for tracking and predicting ridership is provided, comprising one or more multi-passenger vehicles, wherein each of the multi-passenger vehicles have different capacities; a biometric device in each of the one or more multi-passenger vehicles, wherein the biometric device is configured to capture sound data of a number of riders over a predetermined time; a computer configured to analyze the captured sound data from the predetermined time such that a future ridership schedule of the number of riders may be predicted enabling efficient use of one or more multi-passenger vehicles based on the future ridership schedule.

In one embodiment, the biometric device is a smartphone having a microphone, wherein the sound data is captured via the microphone of the smartphone. In one embodiment, efficient use of one or more multi-passenger vehicles is defined as selecting a multi-passenger vehicle having a capacity approximate to the number of riders. In one embodiment, the predetermined time is a time period enabling a ridership pattern to be established, wherein the time period is at least one week. In another embodiment, the one or more multi-passenger vehicles are school buses. In yet another embodiment, the number of riders are students.

In another aspect of the invention, a method for tracking and predicting ridership in a transportation network is provided, comprising steps (a) providing a biometric device on at least one multi-passenger vehicle configured to transport a number of passengers; (b) collecting, via the biometric device, sound data of the number of passengers; (c) analyzing the collected sound data to establish ridership patterns of the number of passengers; and, (d) optimizing the use of the at least one multi-passenger vehicle based on the established ridership patterns.

In one embodiment, in step (a), the biometric device is a smartphone having a microphone, wherein the sound data is captured via the microphone of the smartphone. In another embodiment, in step (a), the at least one multi-passenger vehicle is a school bus. In yet another embodiment, in step (a), the number of passengers are students. In one embodiment, in step (d), the optimization is based on the number of passengers and assigning a multi-passenger vehicle having a capacity approximate to the number of passengers.

The foregoing has outlined rather broadly the more pertinent and important features of the present disclosure so that the detailed description of the invention that follows may be better understood and so that the present contribution to the art can be more fully appreciated. Additional features of the invention will be described hereinafter which form the subject of the claims of the invention. It should be appreciated by those skilled in the art that the conception and the disclosed specific methods and structures may be readily utilized as a basis for modifying or designing other structures for carrying out the same purposes of the present disclosure. It should be realized by those skilled in the art that such equivalent structures do not depart from the spirit and scope of the invention as set forth in the appended claims.

### BRIEF DESCRIPTION OF THE SEVERAL VIEWS OF THE DRAWINGS

Other features and advantages of the present invention will become apparent when the following detailed description is read in conjunction with the accompanying drawings, in which:

FIG. 1 is a system for tracking ridership on a multi-passenger vehicle according to an embodiment of the present invention.

FIG. 2 is an architectural diagram of an Internet computer network system according to an embodiment of the present invention.

FIG. 3 is a method for tracking and predicting ridership on a multi-passenger vehicle according to an embodiment of the present invention.

### DETAILED DESCRIPTION OF THE PREFERRED EMBODIMENT

The following description is provided to enable any person skilled in the art to make and use the invention and sets forth the best modes contemplated by the inventor of carrying out his invention. Various modifications, however, will remain readily apparent to those skilled in the art, since the general principles of the present invention have been defined herein to specifically provide a system and method for tracking and predicting ridership on a multi-passenger vehicle.

Unless the context clearly requires otherwise, throughout the description and the claims, the words “comprise,” “comprising” and the like are to be construed in an inclusive sense as opposed to an exclusive or exhaustive sense; that is to say, in a sense of “including, but not limited to.” Words “a” or “an”, or other words using the singular or plural number also include the plural or singular number, respectively. Additionally, the words “herein,” “above,” “below,” and words of similar import, when used in this application, shall refer to this application as a whole and not to any particular portions of this application.

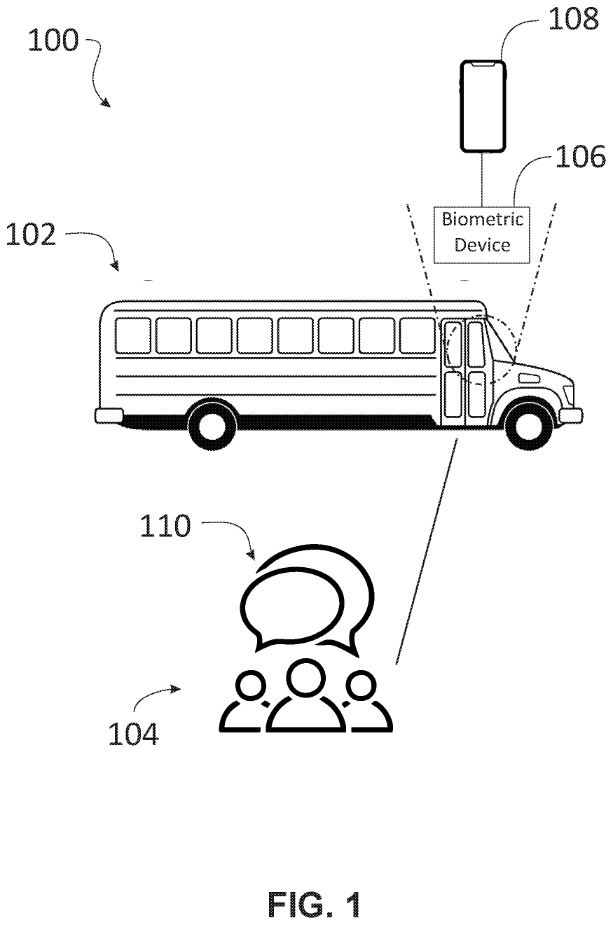

FIG. 1 is a system 100 for tracking ridership 104 on a multi-passenger vehicle 102 according to an embodiment of the present invention. Referring now to FIG. 1, the system 100 is illustrated. The system comprises a multi-passenger vehicle 102, such as a school bus, and a biometric device 106. In one embodiment, the biometric device 106 is a voice analysis or speech recognition device. In one embodiment, the voice analysis or speech recognition device is a smartphone 108. In one embodiment, the smartphone 108 is configured to use the built-in microphone to analyze sound data captured via the microphone. However, it should be understood, that a dedicated voice analysis or speech recognition device may be provided, although it is a particular advantage of the invention to use a smartphone 108, since they are readily available and carried on your person, particularly by the multi-passenger vehicle driver. This will be discussed in greater detail below. In alternative embodiments, the biometric device may be any biometric device known in the art, including but not limited to a facial recognition device, a fingerprint recognition device, an iris recognition device, a retinal scan device, a finger vein recognition device, or similar.

As previously mentioned, it is an object of the present invention to track ridership 104 on a multi-passenger vehicle 102 such that the capacity of the multi-passenger vehicle may be optimized to reduce costs. Advantageously, the biometric device 106 is used to capture the voice data from the riders 104, actively or passively. Reviewing the captured voice data provides information related to how many riders are on the multi-passenger vehicle at any giving time. Analyzing the information enables the ability to establish a pattern of each individual of the riders, or the group of riders as a whole. The analysis can make a determination for each individual's typical schedule of ridership. In this way, the use of the multi-passenger vehicle may be optimized. For example, if there are ten riders on Tuesday morning but twenty riders on Monday, Wednesday, Thursday, and Friday. On Tuesdays, a smaller multi-passenger vehicle with less capacity may be used. This is more economical and efficient than using the larger multi-passenger vehicle. It should be noted that this is just one example, and one skilled in the art may appreciate other scenarios.

In one embodiment, the biometric device, such as smartphone 108, may be carried by the driver of the multi-passenger vehicle. In some embodiments, each individual while entering the multi-passenger vehicle may state their name, or say another trigger word allowing the biometric device to collect, record, authenticate, and/or track each individual and the sound data associated with each individual. In alternative embodiments, the biometric device is passively listening and may collect sound data associated with each individual on the multi-passenger vehicle while the riders are on the vehicle during the route. For instance, the biometric device may collect sound data of riders talking among themselves, footsteps, etc. that can be used, after analysis, to establish the ridership on the multi-passenger vehicle for each day, route, and time.

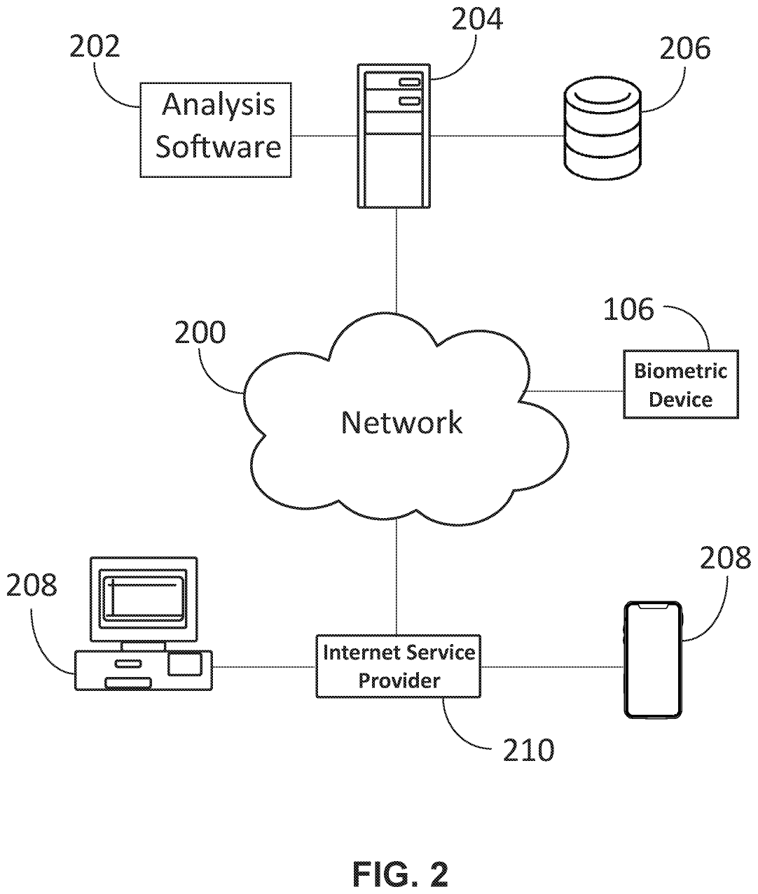

FIG. 2 is an architectural diagram of an Internet computer network system 200 according to an embodiment of the present invention. Referring to FIG. 2, the Internet computer network system 200 is illustrated. In one embodiment, the Internet computer network system comprises one or more Internet-connected servers 204 executing ridership analysis software 202 from non-transitory media. Server 204 is connected to a data repository 206, which may be any sort of data storage known in the art. The biometric device 106 is in communication with the Internet computer network system 200, enabling the data collected from the biometric device 106 to be analyzed via the ridership analysis software 202. The system further comprises a number of authenticated users 208 connected to the Internet-connected server 204 via an Internet service provider (ISP) 210, allowing authenticated users 208 to access the data collected from the biometric device 106 and the ability to access the ridership analysis software 202. It should be understood, that the users 208 may use any computerized device to access the network 200 including, but not limited to, desktops, tablets, and smartphones. The authenticated users are one or more analysts, managers, workers in charge of reviewing the data collected from the biometric device 106, performing the data analysis, to determine a proper schedule for dispatching one or more multi-passenger vehicles with varying capacities depending on the ridership for each route, day, and time.

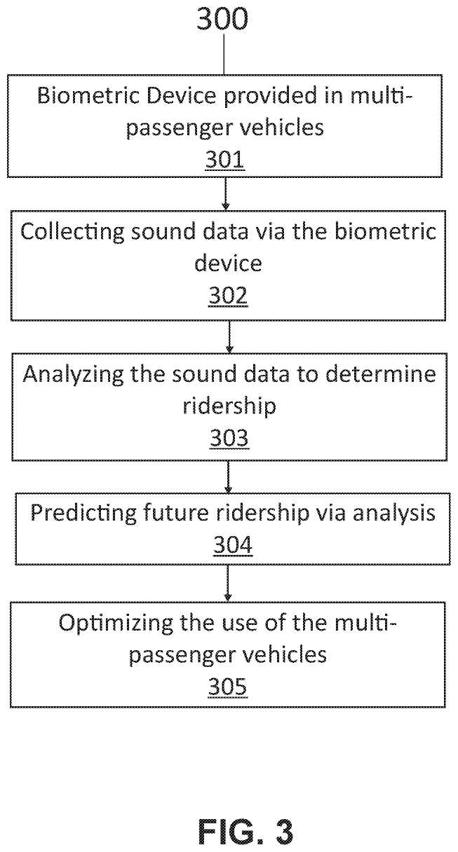

FIG. 3 is a method 300 for tracking and predicting ridership on multi-passenger vehicles according to an embodiment of the present invention. Referring now to FIG. 3, the method 300 for tracking ridership on multi-passenger vehicles (102; FIG. 1) is shown. In step 301, a biometric device is provided in at least one multi-passenger vehicle. The biometric device may be any biometric device as previously discussed. Further, the biometric device may function in any method as previously discussed, such as actively and/or passively. In step 302, the biometric device is configured to collect sound data during the multi-passenger vehicle use. In step 303, the collected sound data from the multi-passenger vehicle is analyzed to determine which individuals are riding the multi-passenger vehicle for each route.

In one embodiment, one or more multi-passenger vehicles are available to accomplish the dedicated routes for one or more transportation networks. For example, one or more school transportation networks, wherein a school transportation network includes the logistics in transporting riders to school from a number of stops and from school to a number of stops.

Still referring to FIG. 3, next in step 304, the analysis enables further ridership predictions. Advantageously, based on the sound data and the analysis over a predetermined time, further ridership may be predicated. For instance, if a disabled rider requiring a ADA multi-passenger vehicle for the last several weeks rode the multi-passenger vehicle to school every Wednesday and Friday, yet only took the multi-passenger vehicle from school on Fridays, then the ADA multi-passenger vehicle wouldn't need to be used in the afternoons on Wednesday, lowering the required costs of operating the ADA multi-passenger vehicle. This is just one example. As one skilled in the art may appreciate, in a non-limiting list, the complex analysis of the number of riders, the requirements of each rider, the stops each rider requires may all be optimized through analysis via the sound data, such that one or more transportation networks may operate as efficiently as possible to reduce the overall cost of maintaining and operating the one or more transportation networks. To that end, in step 305, a number of multi-passenger vehicles, wherein the multi-passenger vehicles have varying capacities and uses (ADA) are dispatched according to the predicted future ridership of step 304 such that the use of the multi-passenger vehicles may be optimized.

Although the invention has been described in considerable detail in language specific to structural features, it is to be understood that the invention defined in the appended claims is not necessarily limited to the specific features described. Rather, the specific features are disclosed as exemplary preferred forms of implementing the claimed invention. Stated otherwise, it is to be understood that the phraseology and terminology employed herein, as well as the abstract, are for the purpose of description and should not be regarded as limiting. Therefore, while exemplary illustrative embodiments of the invention have been described, numerous variations and alternative embodiments will occur to those skilled in the art. Such variations and alternate embodiments are contemplated, and can be made without departing from the spirit and scope of the invention.

For instance, although the present invention describes a biometric device and separate software on a different device for analyzing the sound data, in some embodiments, the biometric device may perform the analysis, or the device which includes the biometric software, i.e. a smartphone, may include the software for analyzing the sound data. Thus, the criticality of the invention isn't the different components of the network system; it is the analysis of sound data to determine the most efficient (cost effective) use of one or more multi-passenger vehicles. In that way, regardless of the arrangement of components, the invention may accomplish its primary goal using any components necessary.

It should further be noted that throughout the entire disclosure, the labels such as left, right, front, back, top, bottom, forward, reverse, clockwise, counter clockwise, up, down, or other similar terms such as upper, lower, aft, fore, vertical, horizontal, oblique, proximal, distal, parallel, perpendicular, transverse, longitudinal, etc. have been used for convenience purposes only and are not intended to imply any particular fixed direction or orientation. Instead, they are used to reflect relative locations and/or directions/orientations between various portions of an object.

In addition, reference to “first,” “second,” “third,” and etc. members throughout the disclosure (and in particular, claims) are not used to show a serial or numerical limitation but instead are used to distinguish or identify the various members of the group.

What is claimed is:

1. A system for tracking and predicting ridership comprising:
one or more multi-passenger vehicles, wherein each of the multi-passenger vehicles have different capacities;
a biometric device in each of the one or more multi-passenger vehicles, wherein the biometric device is configured to capture sound data of a number of riders over a predetermined time;
a computer configured to analyze the captured sound data from the predetermined time such that a future ridership schedule of the number of riders may be predicted enabling efficient use of one or more multi-passenger vehicles based on the future ridership schedule.

2. The system for tracking and predicting ridership of claim 1, wherein the biometric device is a smartphone having a microphone.

3. The system for tracking and predicting ridership of claim 2, wherein the sound data is captured via the microphone of the smartphone.

4. The system for tracking and predicting ridership of claim 1, wherein efficient use of one or more multi-passenger vehicles is defined as selecting a multi-passenger vehicle having a capacity approximate to the number of riders.

5. The system for tracking and predicting ridership of claim 1, wherein the predetermined time is a time period enabling a ridership pattern to be established, wherein the time period is at least one week.

6. The system for tracking and predicting ridership of claim 1, wherein the one or more multi-passenger vehicles are school buses.

7. The system for tracking and predicting ridership of claim 1, wherein the number of riders are students.

8. A method for tracking and predicting ridership in a transportation network comprising steps:
(a) providing a biometric device on at least one multi-passenger vehicle configured to transport a number of passengers;
(b) collecting, via the biometric device, sound data of the number of passengers;
(c) analyzing the collected sound data to establish ridership patterns of the number of passengers; and,
(d) optimizing the use of the at least one multi-passenger vehicle based on the established ridership patterns.

9. The method for tracking and predicting ridership in a transportation network of claim 8, wherein in step (a), the biometric device is a smartphone having a microphone.

10. The method for tracking and predicting ridership in a transportation network of claim 9, wherein the sound data is captured via the microphone of the smartphone.

11. The method for tracking and predicting ridership in a transportation network of claim 8, wherein in step (a), the at least one multi-passenger vehicle is a school bus.

12. The method for tracking and predicting ridership in a transportation network of claim 8, wherein in step (a), the number of passengers are students.

13. The method for tracking and predicting ridership in a transportation network of claim 8, wherein in step (d), the optimization is based on the number of passengers and assigning a multi-passenger vehicle having a capacity approximate to the number of passengers.
